(19) United States
(12) Patent Application Publication
(10) Pub. No.: US 2008/0092830 A1
(43) Pub. Date: Apr. 24, 2008

(54) Fuel Cell System

(75) Inventor: Makoto Suzuki, Sizuoka-ken (JP)

Correspondence Address: OLIFF & BERRIDGE, PLC, P.O. BOX 320850, ALEXANDRIA, VA, 22320-4850, US

(73) Assignee: TOKYO JIDOSHA KABUSHIKI KAISHI, TOYOTA-SHI (JP)

(21) Appl. No.: 11/660,765

(22) PCT Filed: Sep. 5, 2005
(86) PCT No.: PCT/JP05/16680

§ 371 Date: Feb. 22, 2007

(30) Foreign Application Priority Data
Sep. 27, 2004 (JP) 2004-279393

(51) Int. Cl. F02B 43/10; H01M 8/06; F02M 21/02

(52) U.S. Cl. 123/3; 429/19; 700/271; 700/274

(57) ABSTRACT

A fuel cell system includes a fuel cell, a reformer, a fuel supply portion, an oxygen supply portion, a power output portion, a reformed gas supply portion, a determination portion, and a controller. The fuel cell generates electric power through a reaction of hydrogen and oxygen. The reformer generates reformed gas, including hydrogen, from an emission gas of the fuel cell and hydrocarbon fuel through a steam reforming reaction and a partial oxidation reaction. The emission gas of the fuel cell includes steam and the reformer provides the reformed gas to the fuel cell. The fuel supply portion provides the hydrocarbon fuel to the reformer. The oxygen supply portion provides oxygen-including gas to the reformer. The power output portion is activated by at least part of at least one of the reformed gas and the hydrocarbon fuel. The reformed gas supply portion provides the reformed gas to the power output portion. The determination portion determines whether an amount of steam required for the steam reforming reaction is included in the emission gas. The controller controls the oxygen supply portion and the fuel supply portion so that a rate of oxygen provided to the reformer increases as compared to a case where the reformed gas is not provided to the power output portion, if the determination portion determines that the amount of steam required for the steam reforming reaction is not included in the emission gas.

### TECHNICAL FIELD

This invention generally relates to a fuel cell system having a reformer which generates reformed gas used as fuel for a fuel cell from hydrocarbon fuel.

### BACKGROUND ART

One or more aspects of this invention generally relates to fuel cell systems having a reformer that generates, from hydrocarbon fuel, reformed gas that can be used as fuel for a fuel cell.

In general, a fuel cell is a device that obtains electrical power from fuel, hydrogen and oxygen. Fuel cell systems are being widely developed as an energy supply system because fuel cells are environmentally superior and can achieve high energy efficiency.

In a general fuel cell, hydrogen-including reformed gas is conventionally generated from hydrocarbon fuel, such as gasoline, natural gas or methanol, by a reformed gas generator, and the reformed gas is provided to an anode of the fuel cell. In this reformed gas generator, reforming is achieved by a steam reforming reaction that uses steam or the like.

Japanese Patent Application Publication No. 11-311136 (JP'136), for example, proposes providing the reformed gas, which is generated by the reformed gas generator, to a jump spark ignition engine. In the fuel cell system disclosed in JP'136, gasoline and/or hydrogen in the generated reformed gas can be used as fuel for a jump spark ignition engine. It is possible to achieve high heat efficiency with such a fuel cell system.

In such a fuel cell system, it is required, however, to provide a separate or additional device that provides steam to the reformed gas generator to generate the reformed gas by the steam reforming reaction described above. Thus, the size of the fuel cell must be increased to accommodate the steam providing device.

To resolve this problem, Japanese Patent Application Publication No. 2000-195534 (JP'534) proposes introducing the cathode off-gas to a reformed gas generator. The cathode off-gas is emitted from a cathode of a fuel cell that includes an electrolyte with proton conductivity. Thus, JP'534 discloses providing the steam vapor included in the cathode off-gas to the reformed gas generator, and does not require adding a steam vapor generator. It is thus possible to miniaturize the fuel cell.

However, by supplying hydrogen to the jump spark ignition engine, the amount of hydrogen provided to the fuel cell is decreased. This reduces the amount of steam vapor included in the gas that is emitted from the fuel cell. Thus, the reformed gas generator may not be supplied with an amount of hydrogen that is necessary for the steam reforming reaction. So, there is a possibility that carbon may be deposited in the reformed gas generator without completion of the steam reforming reaction.

Various aspects of this invention have been made in view of the above-mentioned circumstances. One or more aspects of the invention provide a fuel cell system that reduces, and preferably eliminates, the deposition of carbon in a reformed gas generator.

### DISCLOSURE OF THE INVENTION

In exemplary embodiments, a fuel cell system includes a fuel cell, a reformer, a fuel supply portion, an oxygen supply portion, a power output portion, a reformed gas supply portion, a determination portion, and a controller. The fuel cell generates electric power through a reaction of hydrogen and oxygen. The reformer generates reformed gas, including hydrogen, from an emission gas of the fuel cell and hydrocarbon fuel through a steam reforming reaction and a partial oxidation reaction. The emission gas of the fuel cell includes steam and the reformer provides the reformed gas to the fuel cell. The fuel supply portion provides the hydrocarbon fuel to the reformer. The oxygen supply portion provides oxygen-including gas to the reformer. The power output portion is activated by at least part of at least one of the reformed gas and the hydrocarbon fuel. The reformed gas supply portion provides the reformed gas to the power output portion. The determination portion determines whether an amount of steam required for the steam reforming reaction is included in the emission gas. The controller controls the oxygen supply portion and the fuel supply portion so that a rate of oxygen provided to the reformer increases as compared to a case where the reformed gas is not provided to the power output portion, if the determination portion determines that the amount of steam required for the steam reforming reaction is not included in the emission gas.

In exemplary embodiments, a method of restraining carbon deposition in a fuel cell system that includes a fuel cell and a combustion engine involves determining whether hydrogen is to be provided to the combustion engine of the fuel cell system. If it is determined that hydrogen is to be provided to the combustion engine, the method further involves calculating an amount of hydrogen that is to be provided to the combustion engine, calculating an amount of hydrocarbon fuel to be provided to a reforming unit of the fuel cell system based on the calculated amount of hydrogen that is to be provided, calculating an amount of steam vapor to be provided to the reforming unit of the fuel cell system based on an amount of hydrogen consumed by the fuel cell, calculating an amount of air to be provided to the reforming unit based on an amount of oxygen used by the fuel cell, and controlling at least one of an injector of the fuel cell system and an air pump of the fuel cell system based on a result of the calculating steps. If it is determined that hydrogen is not to be provided to the combustion engine, the method further involves controlling the injector and the air pump to provide hydrogen and oxygen to the fuel cell. In the exemplary embodiments, the step of controlling results in a greater amount of air to be pumped to the fuel cell when it is determined that hydrogen is to be provided to the combustion engine than when it is determined that hydrogen is not to be provided to the combustion engine.

In exemplary embodiments, a method of restraining carbon deposition in a fuel cell system that includes a fuel cell and a combustion engine involves determining whether hydrogen is to be provided to the combustion engine of the fuel cell system. If it is determined that hydrogen is to be provided to the combustion engine, the method further involves calculating an amount of hydrogen that is to be provided to the combustion engine, calculating an amount of hydrocarbon fuel to be provided to a reforming unit of the fuel cell system based on the calculated amount of hydrogen that is to be provided, calculating an amount of steam vapor to be provided to the reforming unit of the fuel cell system based on an amount of hydrogen consumed by the fuel cell, calculating an amount of air to be provided to the reforming unit based on an amount of oxygen used by the fuel cell, controlling at least one of an injector of the fuel cell system and an air pump of the fuel cell system based on a result of the calculating steps, and controlling a flow control valve of the fuel cell system in a manner that results in a rate of hydrogen being provided to the engine being equal to a desired value. If it is determined that hydrogen is not to be provided to the combustion engine, the method further involves controlling the injector and the air pump to provide hydrogen and oxygen to the fuel cell. In the exemplary embodiments, the step of controlling results in a greater amount of air to be pumped to the fuel cell when it is determined that hydrogen is to be provided to the combustion engine than when it is determined that hydrogen is not to be provided to the combustion engine.

These and other optional features and possible advantages of various aspects of this invention are described in, or are apparent from, the following detailed description of exemplary embodiments of systems and methods which implement this invention.

### EFFECT OF THE INVENTION

In accordance with the invention, it is possible to restrain the carbon from depositing in the reformer completely. In addition, it is not necessary to provide a separate or additional oxygen supply unit and a separate or additional steam vapor supply unit. It is therefore possible to miniaturize the fuel cell system.

### BRIEF DESCRIPTION OF THE DRAWINGS

Exemplary embodiments of one or more aspects of the invention will be described with reference to the following drawings, wherein:

FIG. 1 is a block diagram of an overall configuration of an exemplary fuel cell system according to one or more aspects of the invention;

FIGS. 2A and 2B are graphs illustrating data that may be used by a control unit of the exemplary fuel cell system shown in FIG. 1;

FIG. 3 is a block diagram of a hybrid car in which the fuel cell system shown in FIG. 1 is implemented;

FIG. 4 is a graph illustrating an exemplary relationships between a molar ratio of steam vapor and an air excess coefficient;

FIG. 5 is a flowchart of an exemplary control sequence for providing an internal combustion engine with reformed gas; and

FIG. 6 is a flowchart of another exemplary control sequence for providing an internal combustion engine with reformed gas.

### BEST MODE FOR CARRYING OUT THE INVENTION

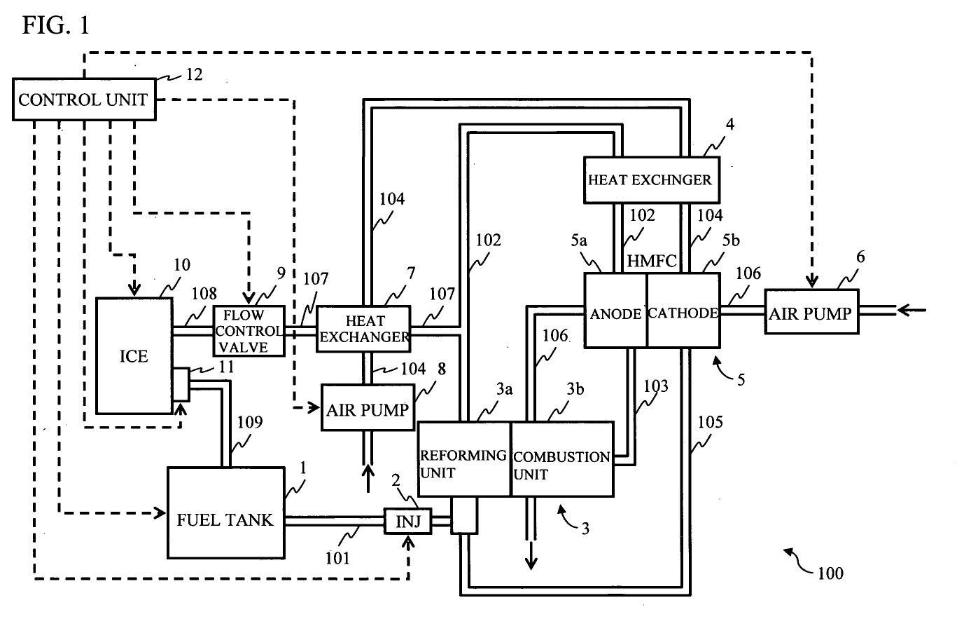

FIG. 1 is a block diagram of an overall configuration of a fuel cell system 100 implementing one or more aspects of the invention. As shown in FIG. 1, the fuel cell system 100 may include a fuel tank 1, injectors 2 and 11, a reformed gas generator 3, heat exchangers 4 and 7, a fuel cell 5, air pumps 6 and 8, a flow control valve 9, an internal combustion engine 10 and a control unit 12. The reformed gas generator 3 may include a reforming unit 3a and a combustion unit 3b. The fuel cell 5 may be a hydrogen permeable membrane fuel cell (HMFC), and may include an anode 5a and a cathode 5b.

In the description of various exemplary embodiments, the term “hydrogen permeable membrane fuel cell” refers to a fuel cell that has a hydrogen permeable membrane layer. A hydrogen permeable membrane layer is a layer formed of a metal that has hydrogen permeability such as, for example, palladium, palladium alloy or the like. The hydrogen permeable membrane fuel cell may be constructed by laminating together a hydrogen permeable membrane layer and an electrolyte having proton conductivity.

Hydrogen provided to the anode 5a of the hydrogen permeable membrane fuel cell 5 is converted into protons by a catalytic agent, and the hydrogen protons move into the electrolyte having proton conductivity. The hydrogen protons and oxygen combine to form water at the cathode 5b of the hydrogen permeable membrane fuel cell 5. Therefore, most of water or steam vapor generated by the fuel cell 5 is included in cathode off-gas.

The fuel tank 1 may be connected to the injector 2 through a pipe 101. The injector 2 may be connected to the reforming unit 3a. The reforming unit 3a may be connected to the anode 5a through a pipe 102. The pipe 102 may pass through the heat exchanger 4. The anode 5a may be connected to the combustion unit 3b through a pipe 103.

The air pump 8 may be connected to the cathode 5b through a pipe 104. The pipe 104 may pass through the heat exchanger 7 and the heat exchanger 4. The cathode 5b may be connected to the reforming unit 3a through a pipe 105. The air pump 6 may be connected to the combustion unit 3b through a pipe 106. The pipe 106 may pass through the fuel cell 5.

One end of the pipe 107 may be connected to the pipe 102 on the upstream side of the heat exchanger 4. Another end of the pipe 107 may be connected to the flow control valve 9. The pipe 107 may also pass through the heat exchanger 7. The flow control valve 9 may be connected to the internal combustion engine 10 through a pipe 108. The fuel tank 1 may be connected to the injector 11 through a pipe 109. The injector 11 may be connected to the internal combustion engine 10.

Operation of the exemplary fuel cell system 100 is described below. Gasoline, as hydrocarbon fuel, may be stored in the fuel tank 1. The fuel tank 1 may receive instructions from the control unit 12, and may provide a required amount of gasoline to the injector 2 through the pipe 101. The injector 2 may receive instructions from the control unit 12, and may provide a required amount of gasoline to the reforming unit 3a.

The reforming unit 3a may reform the gasoline provided by the injector 2 and the cathode off-gas, which is described below, into reformed gas. For reforming the gasoline, a steam reforming reaction may first take place between the gasoline and the steam vapor. For example, the gasoline provided by the injector 2 and the steam vapor included in the cathode off-gas may react together and produce hydrogen and carbon monoxide.

Next, at least a part of the generated carbon monoxide and the steam vapor included in the cathode off-gas may react together and produce hydrogen and carbon dioxide. If there is not enough steam vapor for the steam reforming reaction, the oxygen, which is in the cathode off-gas, and the gasoline may react together and cause a partial oxidation reaction that generates hydrogen and carbon monoxide.

In exemplary embodiments, the steam reforming reaction may be set to occur in the reforming unit 3a when hydrogen is not provided to the internal combustion engine 10 and/or an amount of steam vapor available to the reforming unit is sufficient for the steam reforming reaction. In exemplary embodiments, the partial oxidation reaction may be set to occur in the reforming unit 3a when hydrogen is provided to the internal combustion engine 10 and/or an amount of steam vapor available to the reforming unit 3a is not sufficient for the steam reforming reaction.

The reformed gas generated by the reforming unit 3a may be cooled by air flowing in the pipe 104 and in the heat exchanger 4 before being provided to the anode 5a. At the anode 5a, at least some of the hydrogen that is included in the reformed gas is converted into protons. Hydrogen, which is not converted into protons and carbon monoxide (e.g., hydrogen that did not react in the reforming unit 3a), may be provided to the combustion unit 3b through the pipe 103 as anode off-gas. The anode off-gas may burn with oxygen that is provided from the pipe 106, and be emitted to the outside of the fuel cell system 100. The resulting combustion heat may be used for the steam reforming reaction that occurs in the reforming unit 3a.

As described above, the combustion heat caused by the anode off-gas may serve as fuel for the steam reforming reaction. Thus, it is not necessary to provide a separate or additional fuel tank for combustion. It is therefore possible to miniaturize the fuel cell system 100. In addition, it is possible to completely burn incomplete combustion ingredients included in the anode off-gas (e.g., carbon monoxide) in the combustion unit 3b. It is therefore possible to restrain the deterioration of environment.

The air pump 8 may receive instructions from the control unit 12, and provide air from the outside of the fuel cell system 100 to the pipe 104. This air cools off the reformed gas flowing in the pipe 107 and in the heat exchanger 7, and subsequently cools off the reformed gas flowing in the pipe 102 and through the heat exchanger 4. Then, the air is provided to the cathode 5b.

At the cathode 5b, water and electric power may be generated from the protons converted at the anode 5a and the oxygen included in the air that was provided to the cathode 5b. The water thus generated evaporates into steam vapor with the heat generated in the fuel cell 5. The steam vapor generated at the cathode 5b and the air that does not react with the protons may be provided to the reforming unit 3a through the pipe 105 as the cathode off-gas. As discussed above, the steam vapor and the air that does not react with the protons may be used for the steam reforming reaction and the partial oxidation reaction, respectively.

Because the air that does not react with the protons at the cathode 5b and the steam vapor generated at the cathode 5b may be used for the steam reforming reaction and the partial oxidation reaction, it is not necessary to provide a separate or additional oxygen supply unit and a separate or additional steam vapor supply unit. It is therefore possible to miniaturize the fuel cell system 100.

The air pump 6 may receive instructions from the control unit 12 and accordingly provide air from the outside of the fuel cell system 100 to the pipe 106. The air flowing in the pipe 106 cools off the fuel cell 5, and may be provided to the combustion unit 3b for use in the combustion of hydrogen and carbon monoxide, which are included in the anode off-gas. As discussed above, the air for cooling off the fuel cell 5 may be used for the combustion at the combustion unit 3b. Thus, it is not necessary to provide a separate or an additional oxygen supply unit for burning the anode off-gas. It is therefore possible to miniaturize the fuel cell system 100.

A part of the reformed gas provided to the pipe 102 may be provided to the pipe 107, and may be cooled off by the air flowing in the pipe 104 and in the heat exchanger 7 before being provided to the flow control valve 9. The flow control valve 9 may provide a required amount of the reformed gas to the internal combustion engine 10 through the pipe 108 in accordance with instructions from the control unit 12. In addition, the fuel tank 1 may provide a required amount of gasoline to the injector 11 through the pipe 109 in accordance with instructions from the control unit 12. The injector 11 may provide a required amount of the gasoline to the internal combustion engine 10 in accordance with instructions from the control unit 12.

As discussed above, the reformed gas cooled off in the heat exchanger 7 may be provided to the internal combustion engine 10. It is thus possible to restrain, and preferably prevent, the heat damage and the heat deterioration of the internal combustion engine 10. It is possible to restrain the heat damage and the heat deterioration of, for example, a gasket, electric components, electric wirings or the like in an induction system incorporated in the internal combustion engine 10, by cooling the reformed gas to, for example, about 100 degrees Celsius through about 200 degrees Celsius.

The internal combustion engine 10 generates an air-fuel mixture having a specific air-fuel ratio from at least part of the reformed gas and/or gasoline and air, and operates with combustion of the air-fuel mixture. In this case, the internal combustion engine 10 can operate at high thermal efficiency because of the combination of the hydrogen and the gasoline.

In addition, the control unit 12 may control the air-fuel ratio in the internal combustion engine 10 based on an exemplary base map or graph (e.g., look up table), that is made, for example, in advance, at a time when hydrogen is not provided to the internal combustion engine 10. The control unit 12 may control the air-fuel ratio in the internal combustion engine 10 so that lean combustion corresponding to the amount of hydrogen provided to the internal combustion engine 10 is achieved even when hydrogen is provided to the internal combustion engine 10. In this case, it is possible to enlarge the lean burn limit based on a rate of hydrogen provided to the internal combustion engine 10. It is possible to increase the air excess coefficient (a ratio against a theoretical air-fuel ratio) to about 2, by providing gasoline and hydrogen to the internal combustion engine 10 so that combustion heat of the gasoline provided to the internal combustion engine 10 is, for example, five times that of the hydrogen provided to the internal combustion engine 10. Therefore, gasoline consumption is reduced, and the amount of emission of nitrogen oxide is reduced.

It is possible to select either or both of the electric power generated by the fuel cell 5 or the motive power generated by the internal combustion engine 10 because the exemplary fuel cell system 100 implementing one or more aspects of the invention may include the fuel cell 5 and the internal combustion engine 10. It is accordingly possible to generate an appropriate output based on the operation condition of the fuel cell system 100.

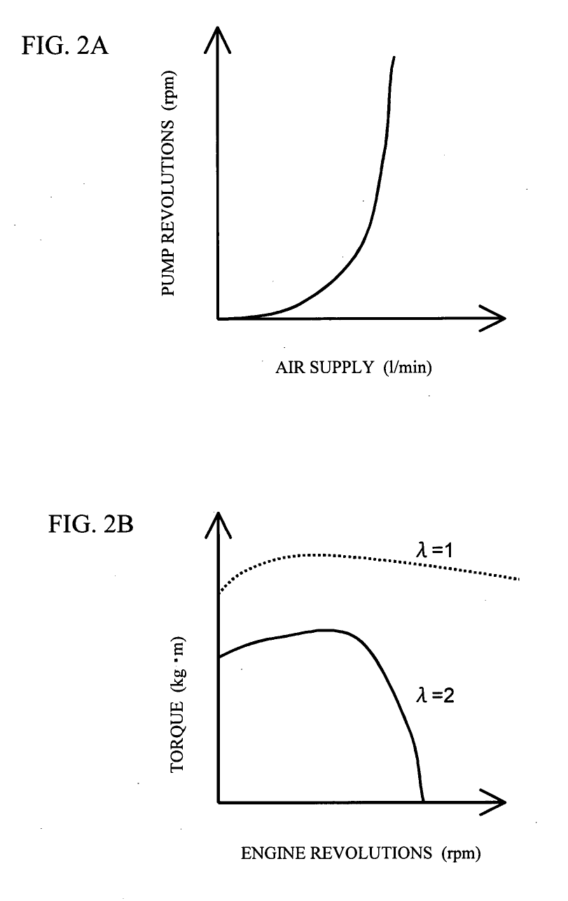

FIGS. 2A and 2B illustrate data illustrated graphically in an exemplary graph or map (e.g., look up tables or graphs) that can be used by the control unit 12 for controlling the air pump 8, the flow control valve 9, the internal combustion engine 10 and the injector 11. More particularly, FIG. 2A illustrates a graph or map showing a relationship between air supply by the air pump 8 and pump revolutions of the air pump 8. The vertical axis of FIG. 2A indicates the pump revolutions of the air pump 8, and the horizontal axis of FIG. 2A indicates the air supply by the air pump 8. As shown in FIG. 2A, the pump revolutions of the air pump 8 increase in proportion to the square of the air supply by the air pump 8. The control unit 12 may control the air pump 6 and 8 based, for example, on the exemplary graph or map shown in FIG. 2A.

FIG. 2B illustrates an exemplary graph or map showing an exemplary relationship between the revolutions of the internal combustion engine 10, the torque of the internal combustion engine 10 and an air excess coefficient λ. The vertical axis of FIG. 2B indicates the torque of the internal combustion engine 10, and the horizontal axis of FIG. 2B indicates the revolutions of the internal combustion engine 10. A broken or dashed line in FIG. 2B indicates a relationship between the torque and the revolutions of the internal combustion engine when the air excess coefficient λ is 1. A solid line in FIG. 2B indicates a relationship between the torque and the revolutions of the internal combustion engine when the air excess coefficient λ is 2. Although, as shown in FIG. 2B, the torque of the internal combustion engine 10 increases with an increase of the revolutions of the internal combustion engine 10, the torque of the internal combustion engine 10 decreases with an increase of the revolutions of the internal combustion engine 10 when the revolutions of the internal combustion engine 10 exceed a specific number of revolutions. The control unit 12 may control the flow control valve 9, the internal combustion engine 10 and the injector 11, based on the data illustrated in the exemplary graph or map shown in FIG. 2B.

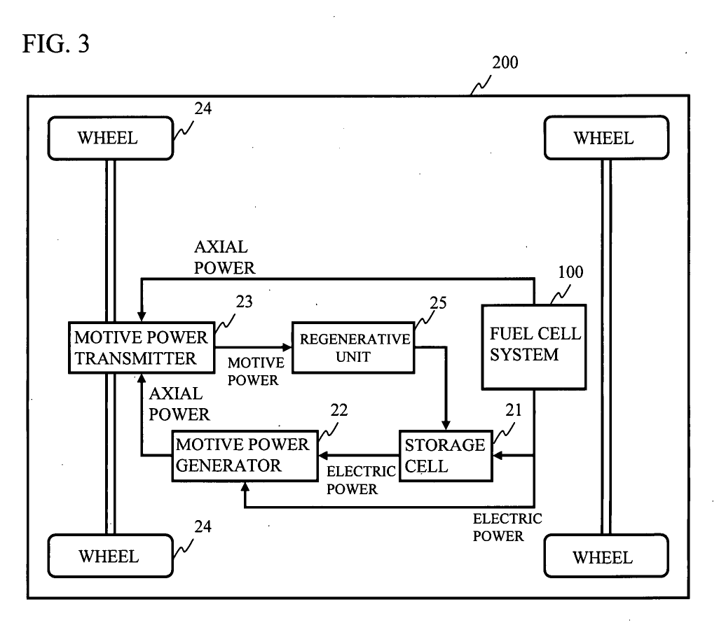

FIG. 3 schematically shows the exemplary fuel cell system 100 applied to a hybrid car. As shown in FIG. 3, an exemplary hybrid car 200 may employ the fuel cell system 100, a storage cell 21, a motive power generator 22, a motive power transmitter 23, wheels 24 and a regenerative unit 25.

The electric power generated at the fuel cell 5 of the fuel cell system 100 may be provided to the motive power generator 22, and may be alternatively provided to the motive power generator 22 after being stored in the storage cell 21. The motive power generator 22 may include a converter, an inverter, an electric motor and so on. The motive power generator 22 may convert electric power provided from the fuel cell system 100 or the storage cell 21 into axial power, and may transmit the axial power to the motive power transmitter 23. The motive power transmitter 23 may transmit the axial power to the wheels 24 to being operation of the hybrid car 200.

Subsequently, the hybrid car 200 may switch from using the motive power source to using the internal combustion engine according to an increase of the duty. First, the motive power transmitter 23 may stop providing the axial power from the motive power generator 22. Next, the motive power generated by the internal combustion engine 10 of the fuel cell system 100 may be provided to the motive power transmitter 23, as axial energy. The motive power transmitter 23 may provide the axial power to the wheels 24. When the duty increases further, the motive power transmitter 23 may transmit the axial power provided from both the internal combustion engine 10 of the fuel cell system 100 and the motive power generator 22 to the wheels 24.

The regenerative unit 25 may include a generator. For example, when a user decelerates the hybrid car 200, the generator of the regenerative unit 25 may convert the motive power of the wheels 24 into the electric power, and may provide the converted electric power to the storage cell 21.

As discussed above, it is possible to select one or both of an electric motor or an internal combustion engine based on the operation condition by employing the exemplary fuel cell system 100 in a hybrid car. It is therefore possible to improve the thermal efficiency.

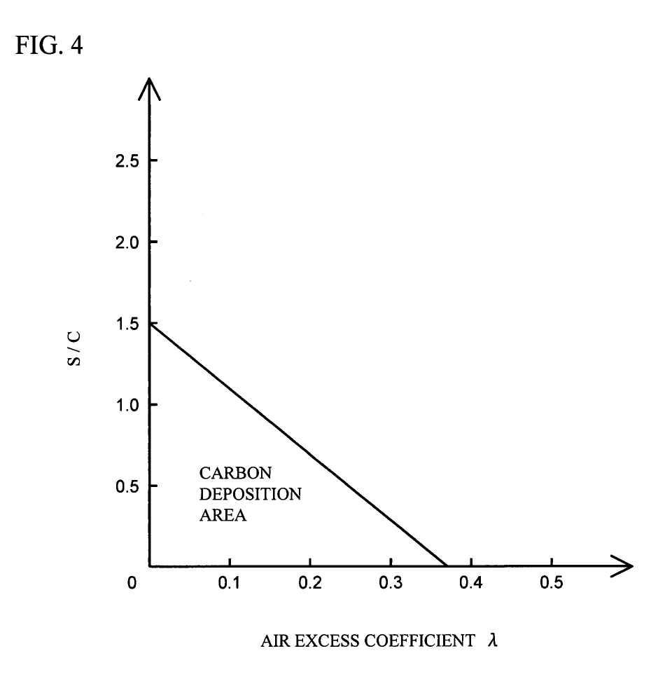

Next, a description will be given of carbon deposition in the reforming unit 3a shown in FIG. 1. FIG. 4 is a graph that will be used to explain carbon deposition. The vertical axis of FIG. 4 indicates a ratio S/C in the reforming unit 3a, and the horizontal axis of FIG. 4 indicates the air excess coefficient λ. As used herein, the term “ratio S/C” means a molar ratio of steam vapor provided to the reforming unit 3a to carbon in the gasoline provided to the reforming unit 3a.

As shown in FIG. 4, when the ratio S/C is more than 1.5, the amount of steam vapor provided to the reforming unit 3a is greater than the amount of gasoline provided to the reforming unit 3a, and thus, carbon is not deposited. However, the amount of steam vapor generated at the cathode 5b decreases as the amount of the reformed gas provided to the internal combustion engine 10 increases. Therefore, the amount of steam vapor provided to the reforming unit 3a decreases and the ratio S/C decreases as the amount of the reformed gas provided to the internal combustion engine 10 increases. As shown in FIG. 4, when the ratio S/C is below 1.5, the reforming unit 3a runs short of steam vapor for the steam reforming reaction and thus, carbon can deposit in the reforming unit 3a.

In this case, it is possible to increase the air excess coefficient λ in the reforming unit 3a, by increasing the air supply from the air pump 8. It is therefore possible to restrain the carbon from depositing in the reforming unit 3a completely. Even if the ratio S/C is reduced to 0, it is possible to restrain the carbon deposition in the reforming unit 3a completely by controlling the air excess coefficient λ to be more than 0.4.

Next, a description will be given of exemplary methods for restraining, and preferably eliminating, carbon deposition in the reforming unit 3a when the internal combustion engine 10 is operating.

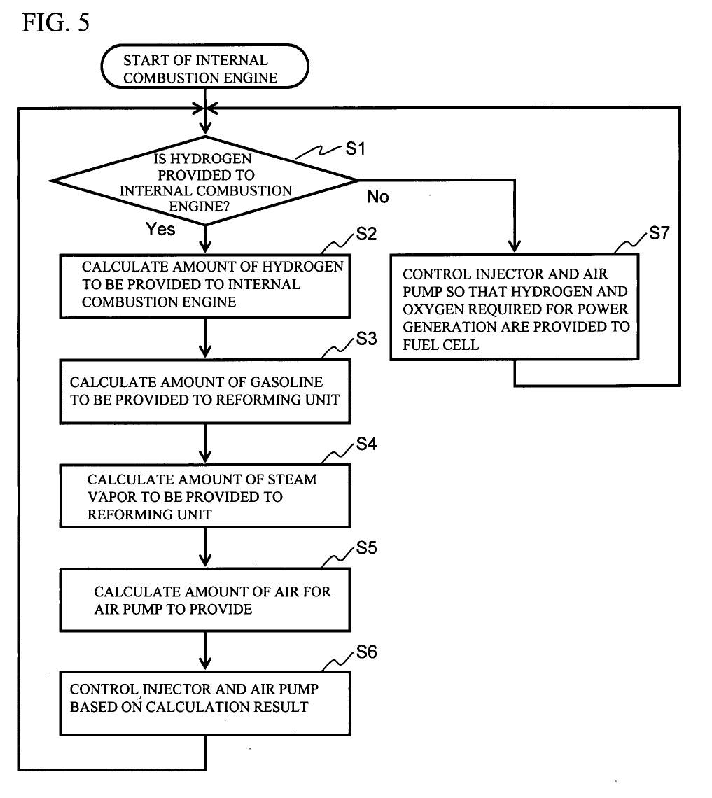

FIG. 5 is a flowchart of an exemplary control sequence of the control unit 12.

As shown in FIG. 5, after starting the internal combustion engine 10, the control unit 12 may determine whether hydrogen is to be provided to the internal combustion engine 10 (step S1). In particular, the control unit 12 may carry out step S1 based, for example, on whether the internal combustion engine 10 revolves at high intensity or at high velocity. If it is determined that it is required to provide hydrogen to the internal combustion engine 10 in step S1, the control unit 12 may then calculate an amount of hydrogen to be provided to the internal combustion engine 10 (step S2). In this case, the amount of hydrogen may be calculated so that the combustion heat of gasoline provided to the internal combustion engine 10 is five times as much as that of hydrogen provided to the internal combustion engine 10.

Next, the control unit 12 may calculate an amount of gasoline to be provided to the reforming unit 3a based, for example, on the amount of hydrogen described above and an amount of hydrogen required for an operation of the fuel cell 5 (step S3). Then, the control unit 12 may calculate an amount of steam vapor to be provided to the reforming unit 3a from the cathode 5b, based, for example, on the amount of hydrogen consumed at the anode 5a (step S4).

Next, the control unit 12 may calculate an amount of air to be provided to the cathode 5b by the air pump 8, based, for example, on the amount of oxygen consumed at the cathode 5b and the amount of oxygen required for the carbon not to be deposited in the reforming unit 3a (step S5). In this case, the amount of oxygen required for the carbon not to be deposited may be calculated, for example, based on the data in the graph shown in FIG. 4.

Then, the control unit 12 may control the injector 2 based on the calculation result in the step S3, and may control the air pump 8 based on the calculation result in the step S5 (step S6). In this case, the control unit 12 may refer to the graph in FIG. 2A and use the data contained in the graph to control the air pump 8. Then, the control unit 12 may start the sequence over from step S1.

If it is determined that it is not required to provide hydrogen to the internal combustion engine 10 in step S1, the control unit 12 may control the injector 2 and the air pump 8 so that an amount of hydrogen and oxygen required for the electric power generation of the fuel cell 5 are provided to the anode 5a and to the cathode 5b respectively (step S7). In this case, the control unit 12 may refer to the graph shown in FIG. 2A, and use the data contained in the graph shown in FIG. 2A to control the air pump 8. Then, the control unit 12 may start the sequence over from step S1.

In exemplary embodiments, even if the reforming unit runs short of the steam vapor necessary for the steam reforming reaction, a rate of oxygen supply is increased to completely or at least substantially restrain the carbon deposition in the reforming unit 3a.

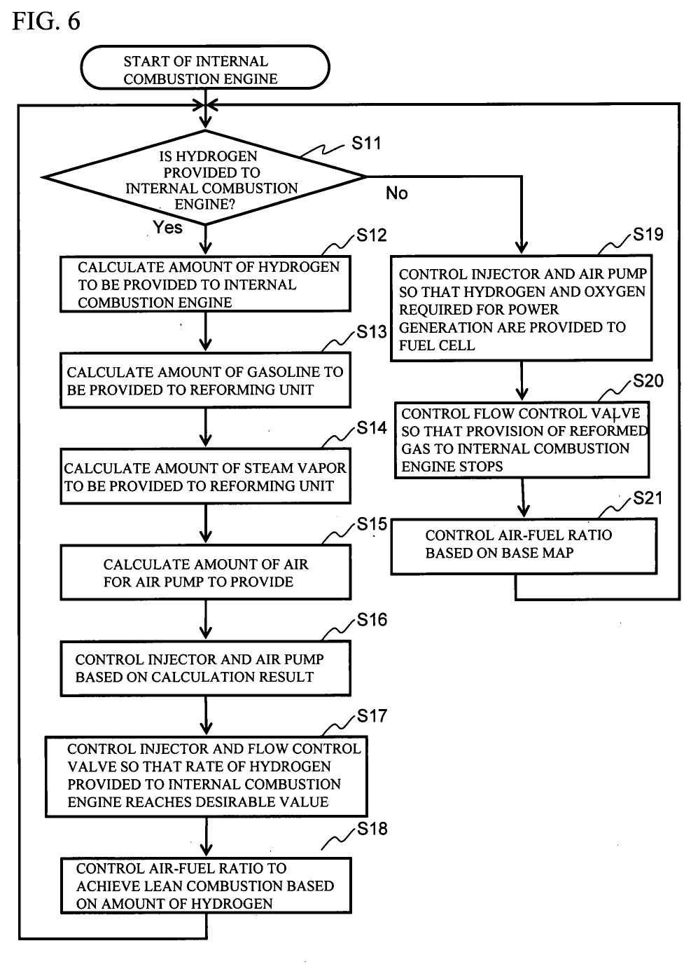

FIG. 6 is a flowchart of another exemplary control sequence of the control unit 12 that may be used for restraining, and preferably eliminating, carbon deposition in the reforming unit 3a when the internal combustion engine 10 is operating. As is shown in FIG. 6, the control unit 12 may determine whether it is required to provide hydrogen to the internal combustion engine 10 (step S1). More particularly, the control unit 12 may carry out the step (step S1) based on whether the internal combustion engine 10 revolves at high intensity or at high velocity. If it is determined that it is required to provide hydrogen to the internal combustion engine 10 in step S11, the control unit 12 may then compute an amount of hydrogen to be provided to the internal combustion engine 10 (step S12). In this case, the amount of hydrogen may be calculated so that the combustion heat of gasoline provided to the internal combustion engine 10 is as much as five times that of hydrogen provided to the internal combustion engine 10.

Next, the control unit 12 may calculate an amount of gasoline to be provided to the reforming unit 3a based, for example, on the amount of hydrogen described above and an amount of hydrogen required for the operation of the fuel cell 5 (step S113). Then, the control unit 12 may calculate an amount of steam vapor to be provided to the reforming unit 3a from the cathode 5b, based on the amount of hydrogen consumed at the anode 5a (step S14).

Next, the control unit 12 may calculate an amount of air to be provided to the cathode 5b by the air pump 8, based, for example, on the amount of oxygen consumed at the cathode 5b and an amount of oxygen required for the carbon not to be deposited in the reforming unit 3a (step S15). In this case, the amount of oxygen required for the carbon not to be deposited may be calculated based on the data contained in the graph shown in FIG. 4.

Then, the control unit 12 may control the injector 2 based on the calculation result in the step S13, and may control the air pump 8 based on the calculation result in step S15 (step S16). In this case, the control unit 12 may refer to the graph shown in FIG. 2A, and use the data contained in the graph shown in FIG. 2A to control the air pump 8. Then, the control unit 12 may start the sequence over from the step S11.

Next, the control unit 12 may control the flow control valve 9 and the injector 11 so that a ratio between hydrogen and gasoline provided to the internal combustion engine 10 can reach a desired value (step S17). In this case, the flow control valve 9 and the injector 11 may be controlled so that the combustion heat of gasoline to be provided to the internal combustion engine 10 is five times that of hydrogen to be provided to the internal combustion engine 10. Then, the control unit 12 may control the air-fuel ratio in the internal combustion engine 10 so that the air excess coefficient λ can reach about 2. Then, the control unit 12 may start the sequence over from the step S11.

If it is determined that it is not required to provide hydrogen to the internal combustion engine 10 in step S11, the control unit 12 may control the injector 2 and the air pump 8 so that the amounts of hydrogen and oxygen required for the electric power generation of the fuel cell 5 are provided to the anode 5a and to the cathode 5b, respectively (step S19). In this case, the control unit 12 may refer to graph shown in FIG. 2A, and use the data contained in the graph shown in FIG. 2A to control the air pump 8.

Next, the control unit 12 may control the flow control valve 9 so that the supply of hydrogen is stopped (step S20). Then, the control unit 12 may control the air-fuel ratio in the internal combustion engine 10 by referring to base map that is made in advance, at a time when hydrogen is not provided to the internal combustion engine 10. (step S21). Then, the control unit 12 may start the sequence over from step S11.

As described above, the air-fuel ratio may be controlled based on the amount of hydrogen provided to the internal combustion engine 10, so that combustion at high thermal efficiency can be achieved. In addition, even if the reforming unit 3a runs short of steam vapor for the steam reforming reaction, the rate of oxygen supply is increased so that the deposition of carbon in the reforming unit 3a can be restrained, and preferably eliminated.

In the exemplary embodiments described above, the reformed gas generator 3 may correspond to the reformer, the anode off-gas and the cathode off-gas may correspond to the emission gas, the injector 2 may correspond to the fuel supply portion, the air pump 8 may correspond to the oxygen supply portion, the internal combustion engine 10 may correspond to the power output portion, the flow control valve 9 may correspond to the reformed gas supply portion, and the control unit 12 may correspond to the determination portion and the controller.

The aforementioned exemplary embodiments employ, as a power output unit, the internal combustion engine 10 used for a gasoline engine. Instead, it is possible, for example, to use another internal combustion such as a hydrogen combustion turbine or an external combustion engine using hydrogen, as fuel. In exemplary embodiments, the hydrogen permeable membrane fuel cell used as the fuel cell 5 may be substituted for another type of fuel cell such as a solid oxide fuel cell. In such embodiments, it is possible to use steam vapor included in the anode off-gas for the steam reforming reaction in the reforming unit 3a. Further, in exemplary embodiments, gasoline used as hydrocarbon fuel may be substituted for another hydrocarbon fuel such as natural gas or methanol.

Throughout the following description, numerous specific concepts and structures are set forth in order to provide a thorough understanding of the invention. The invention can be practiced without utilizing all of these specific concepts and structures. In other instances, well known elements have not been shown or described in detail, so that emphasis can be focused on the invention.

The fuel cell system according to one or more aspects of the invention may include a fuel cell, a reformer, a fuel supply portion, an oxygen supply portion, a power output portion, a reformed gas supply portion, a determination portion and a controller. The fuel cell may generate electric power by the reaction of hydrogen and oxygen. The reformer may generate reformed gas including hydrogen from emission gas of the fuel cell and hydrocarbon fuel through steam a steam reforming reaction and a partial oxidation reaction. The emission gas of the fuel cell includes steam. The reformer may provide the reformed gas to the fuel cell. The fuel supply portion provides the hydrocarbon fuel to the reformer, an oxygen supply portion may provide oxygen-including gas to the reformer. The power output portion may be activated by at least part of the reformed gas and/or hydrocarbon fuel. The reformed gas supply portion may provide the reformed gas to the power output portion. The determination portion may determine whether steam required for the steam reforming reaction is included in the emission gas. If the determination portion determines that the steam required for the steam reforming reaction is not included in the emission gas, the controller may control the oxygen supply portion and the fuel supply portion and increases a rate of oxygen provided to the reformer. That is, when the reformed gas is provided to the power output portion, more oxygen is provided to the reformer.

In exemplary embodiments, oxygen may be provided to the reformer by the oxygen supply portion and the emission gas may be provided to the reformer from the fuel cell. The hydrocarbon fuel may be provided to the reformer by the fuel supply portion in exemplary embodiments. In exemplary embodiments, the reformed gas including hydrogen is generated by the reformer through the steam reforming reaction and the partial oxidation reaction. In exemplary embodiments, the steam reforming reaction and the partial oxidation reaction may utilize the oxygen, the emission gas and the hydrocarbon fuel provided by the oxygen supply portion, the fuel cell and the fuel supply portion, respectively. In exemplary embodiments, a required amount of the reformed gas may be provided to the power output portion by the reformed gas supply portion.

In exemplary embodiments, it may determined whether a sufficient amount of steam required for the steam reforming reaction is included in the emission gas. If it is determined that the amount of steam required for the steam reforming reaction is not included in the emission gas, the oxygen supply portion and the fuel supply portion may be controlled by the controller so that a rate of oxygen provided to the reformer is higher than an amount of oxygen that is provided when the reformed gas is not provided to the power output portion.

In exemplary embodiments, even if the reforming unit runs short of steam vapor needed for the steam reforming reaction, a rate of oxygen supply is increased to restrain, and preferably prevent, the carbon deposition in the reformer through the partial oxidation reaction. In embodiments, steam included in the emission gas emitted from the fuel cell may be used for the steam reforming reaction and the partial oxidation reaction. It is thus not required to provide another oxygen supply portion and another steam vapor supply portion. It is therefore possible to miniaturize the fuel cell system.

In embodiments, the oxygen supply portion may provide the cathode off-gas emitted from a cathode of the fuel cell to the reformer. In this case, the air not used for cathode reaction may be used for the partial oxidation reaction. It is thus not required to provide another oxygen supply portion. It is therefore possible to miniaturize the fuel cell system.

In exemplary embodiments, an electrolyte of the fuel cell may have proton conductivity and the emission gas of the fuel cell including steam may be the cathode off-gas from the fuel cell. In such embodiments, water is generated at the cathode of the fuel cell, and a great amount of water or steam is included in the cathode off-gas. It is thus possible to provide both oxygen and steam to the reformer by the oxygen supply portion. It is therefore not required to provide another steam vapor supply portion. Accordingly, it is possible to miniaturize the fuel cell system.

In exemplary embodiments, the power output portion may generate fuel-air mixture from at least part of the reformed gas and/or the hydrocarbon fuel and air, and may be an internal combustion engine that burns the fuel-air mixture. In such embodiments, it is possible to apply the fuel cell system in accordance with one or more aspects of the invention to a hybrid car or the like. It is thus possible to improve the thermal efficiency by selecting motive power based on the operation condition of the hybrid car.

In exemplary embodiments, the controller may control the power output portion to have lean combustion based on an amount of the reformed gas that is provided to the power output portion. In such embodiments, the lean burn limit is enlarged based on hydrogen gas supply. Thus hydrocarbon fuel consumption is reduced, and an amount of emission of nitrogen oxide is reduced.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the claims as filed and as they may be amended are intended to embrace all known or later-developed alternatives, modifications, variations, improvements, and/or substantial equivalents.

1. A fuel cell system comprising:
a fuel cell generating electric power through a reaction of hydrogen and oxygen;
a reformer that generates reformed gas, including hydrogen, from an emission gas of the fuel cell, which includes steam, and hydrocarbon fuel through a steam reforming reaction and a partial oxidation reaction, and the reformer providing the reformed gas to the fuel cell;
a fuel supply portion that provides the hydrocarbon fuel to the reformer;
an oxygen supply portion that provides oxygen-including gas to the reformer;
a power output portion that is activated by at least part of at least one of the reformed gas and the hydrocarbon fuel;
a reformed gas supply portion that provides the reformed gas to the power output portion;
a determination portion that determines whether an amount of steam required for the steam reforming reaction is included in the emission gas; and
a controller that controls the oxygen supply portion and the fuel supply portion so that a rate of oxygen provided to the reformer increases as compared to a case where the reformed gas is not provided to the power output portion, if the determination portion determines that the amount of steam required for the steam reforming reaction is not included in the emission gas.

2. The fuel cell system as claimed in claim 1, wherein the oxygen supply portion provides cathode off-gas emitted from a cathode of the fuel cell to the reformer.

3. The fuel cell system as claimed in one of the claim 1, wherein:
an electrolyte of the fuel cell has proton conductivity; and
the emission gas of the fuel cell that includes steam is the cathode off-gas from the fuel cell.

4. The fuel cell system as claimed in any one of the claim 1, wherein the power output portion generates a fuel-air mixture from at least part of at least one of the reformed gas and the hydrocarbon fuel and air, and is an internal combustion engine that burns the fuel-air mixture.

5. The fuel cell system as claimed in any one of the claim 1, wherein the controller controls the power output portion so as to have lean combustion based on an amount of the reformed gas provided to the power output portion.

6. The fuel cell system as claimed in any one of the claim 1, wherein fuel cell is a hydrogen permeable membrane fuel cell.

7. A method of restraining carbon deposition in a fuel cell system that includes a fuel cell and a combustion engine, the method comprising:
determining whether hydrogen is to be provided to the combustion engine of the fuel cell system;
if it is determined that hydrogen is to be provided to the combustion engine:
calculating an amount of hydrogen that is to be provided to the combustion engine;
calculating an amount of hydrocarbon fuel to be provided to a reforming unit of the fuel cell system based on the calculated amount of hydrogen that is to be provided;
calculating an amount of steam vapor to be provided to the reforming unit of the fuel cell system based on an amount of hydrogen consumed by the fuel cell;
calculating an amount of air to be provided to the reforming unit based on an amount of oxygen used by the fuel cell; and
controlling at least one of an injector of the fuel cell system and an air pump of the fuel cell system based on a result of the calculating steps, and
if it is determined that hydrogen is not to be provided to the combustion engine, controlling the injector and the air pump to provide hydrogen and oxygen to the fuel cell, wherein:
the step of controlling results in a greater amount of air to be pumped to the fuel cell when it is determined that hydrogen is to be provided to the combustion engine than when it is determined that hydrogen is not to be provided to the combustion engine.

8. The method as claimed in claim 7, wherein determining whether hydrogen is to be provided to the combustion engine of the fuel cell system comprises determining an operation state of the combustion engine.

9. The method as claimed in one of the claim 7, wherein calculating an amount of hydrogen that is to be provided to the combustion engine comprises determining an amount of hydrogen that will give rise to an amount of combustion heat having a value that is about five times a value of the amount of hydrogen provided to the combustion engine.

10. The method as claimed in any one of the claim 7, wherein calculating an amount of air comprises determining the amount of oxygen used at a cathode of the fuel cell.

11. The method as claimed in any one of the claim 7, wherein controlling at least one of an injector of the fuel cell system and an air pump of the fuel cell system comprises controlling an air-fuel ratio in the combustion engine so that an air excess coefficient reaches about 2.

12. The method as claimed in any one of the claim 7, wherein a molar ratio of the steam vapor to be provided to the reforming unit to carbon in the hydrocarbon fuel provided to the reforming unit is greater than or equal to 1.5.

13. The method as claimed in any one of the claim 7, wherein controlling at least one of an injector of the fuel cell system and an air pump of the fuel cell system comprises controlling the injector and the air pump in a manner that causes the amount of steam vapor provided to the reforming unit to be greater than the amount of hydrocarbon fuel being provided to the reforming unit.

14. A method of restraining carbon deposition in a fuel cell system that includes a fuel cell and a combustion engine, the method comprising:
determining whether hydrogen is to be provided to the combustion engine of the fuel cell system;
if it is determined that hydrogen is to be provided to the combustion engine:
calculating an amount of hydrogen that is to be provided to the combustion engine;
calculating an amount of hydrocarbon fuel to be provided to a reforming unit of the fuel cell system based on the calculated amount of hydrogen that is to be provided;
calculating an amount of steam vapor to be provided to the reforming unit of the fuel cell system based on an amount of hydrogen consumed by the fuel cell;
calculating an amount of air to be provided to the reforming unit based on an amount of oxygen used by the fuel cell;
controlling at least one of an injector of the fuel cell system and an air pump of the fuel cell system based on a result of the calculating steps, and
controlling a flow control valve of the fuel cell system in a manner that results in a rate of hydrogen being provided to the engine being equal to a desired value; and
if it is determined that hydrogen is not to be provided to the combustion engine, controlling the injector and the air pump to provide hydrogen and oxygen to the fuel cell, wherein:
the step of controlling results in a greater amount of air to be pumped to the fuel cell when it is determined that hydrogen is to be provided to the combustion engine than when it is determined that hydrogen is not to be provided to the combustion engine.

15. The method as claimed in claim 14, wherein determining whether hydrogen is to be provided to the combustion engine of the fuel cell system comprises determining an operation state of the combustion engine.

16. The method as claimed in one of the claim 14, wherein calculating an amount of hydrogen that is to be provided to the combustion engine comprises determining an amount of hydrogen that will give rise to an amount of combustion heat having a value that is about five times a value of the amount of hydrogen provided to the combustion engine.

17. The method as claimed in any one of the claim 14, wherein calculating an amount of air comprises determining the amount of oxygen used at a cathode of the fuel cell.

18. The method as claimed in any one of the claim 14, wherein controlling at least one of an injector of the fuel cell system and an air pump of the fuel cell system comprises controlling an air-fuel ratio in the combustion engine so that an air excess coefficient reaches about 2.

19. The method as claimed in any one of the claim 14, wherein a molar ratio of the steam vapor to be provided to the reforming unit to carbon in the hydrocarbon fuel provided to the reforming unit is greater than or equal to 1.5.

20. The method as claimed in any one of the claim 14, wherein controlling at least one of an injector of the fuel cell system and an air pump of the fuel cell system based on a result of the calculating steps comprises controlling both the injector and the air pump utilizing a predetermined look up table.
